(19) United States
(12) Patent Application Publication
(10) Pub. No.: US 2024/0080221 A1
(43) Pub. Date: Mar. 7, 2024

(54) FIFTH GENERATION (5G) HYBRID DATA OVER CABLE SERVICE INTERFACE SPECIFICATION (DOCSIS) 5G NEW RADIO (NR) SYSTEM

(71) Applicant: Telefonaktiebolaget LM Ericsson (publ), Stockholm (SE)

(72) Inventors: Roland SMITH, Nepean (CA); Stephen RAYMENT, Ottawa (CA); Miguel BERG, Sollentuna (SE); Elmar TROJER, Täby (SE)

(21) Appl. No.: 18/262,239

(22) PCT Filed: Feb. 10, 2022
(86) PCT No.: PCT/IB2022/051211

§ 371 Date: Jul. 20, 2023

Related U.S. Application Data
(60) Provisional application No. 63/147,928, filed on Feb. 10, 2021.

(51) Int. Cl. H04L 12/28

(52) U.S. Cl. CPC H04L 12/2861; H04W 88/14

(57) ABSTRACT

A method, system and apparatus for a hybrid DOCSIS-5G NR system are disclosed. According to one aspect, a method includes implementing, in a first network node a hybrid coax fiber (HFC) centralized access architecture (I-CCAP) modified to include a wireless core. The method also includes establishing communication links from the wireless core to radio equipment of a second network node. According to another aspect, a method provides implementing, in the second network node, a remote physical architecture (R-PHY), the R-PHY configured to communicate with a CCAP core of the I-CAPP of the first network node, and implementing in the first node, radio base station (RBS) equipment configured to communicate with the R-PHY to enable wireless communication system services to consumer premises equipment (CPE).

### FIELD

The present disclosure relates to wireless communications, and in particular, to a hybrid Data Over Cable Service Interface Specifications (DOCSIS)-Fourth Generation (4G) Long Term Evolution (LTE) and/or Fifth Generation (5G) New Radio (NR) system.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

Data Over Cable Service Interface Specifications (DOCSIS) is a globally-recognized telecommunications standard that enables high-bandwidth data transfer via existing coaxial cable systems that were originally used in the transmission of cable television program (CATV) signals. Cable television (TV) networks, which started in the 1950s in limited applications, came into mainstream popularity in the 1980's with the ability to carry 12, over the air (OTA), very high frequency (VHF) TV channels, as well as a growing number of ultra-high frequency (UHF) channels. Cable networks were further extended to carry frequency modulation (FM) radio stations, thereby delivering a wide variety of broadcast services to the home.

The beginnings of the Internet led to DOCSIS, which began a standards evolution to deliver more value-added services and increasingly higher upstream and downstream data rates to an increasing customer base.

DOCSIS 1.0 was formally released in 1997 and provided interworking guidelines for Internet content with existing video content and other content, such as FM radio. Services were sourced in the headend network for transport over the HFC “hybrid fiber coaxial” cable network. Channel plan and signal levels were defined in documents such as DOCSIS 1.0 ANSI/SCTE 23-1 2002 (formerly DSS 02-09).

DOCSIS 1.1 introduced Quality of Service (QoS) necessary for voice over Internet protocol (VoIP). DOCSIS 2.0 introduced expanded upstream capabilities and perhaps most importantly, Internet protocol (IP) telephony services that were seeing wide-spread industry acceptance. This new feature enabled cable operators through DOCSIS to offer telephony services previously offered solely by wireline telephony providers. In parallel with this evolution, home cable MODEM chipsets were configured to offer Ethernet 10/100BT wide area network (WAN) and local area network (LAN) interfaces, thereby eliminating home requirements for multiport switches and gateways.

DOCSIS 3.0 expanded upstream and downstream data rates and introduced channel bonding. Further, many of the chipsets now utilized the higher data rates to offer integrated Wi-Fi chipsets for wireless communications. DOCSIS 3.1 widened channels from 6 and 8 MHz to 100 MHz introducing well proven orthogonal frequency division multiplexing (OFDM) technology as it followed a parallel path with the use of OFDM technology by the 3GPP. Also, wider carriers and narrower subcarriers were employed to enable low latency, highly efficient shared data pipes with Wi-Fi integrated into the Cable MODEMs. This enabled local tethering and limited wideband local area network (WLAN) capabilities, with WAN/LAN services at higher giga-bit rates. BLUETOOTH capabilities were also introduced.

DOCSIS 4.0 is making a significant leap to widen the cable plant spectrum to 1.8 GHz in upstream and downstream directions with time division duplex (TDD) operation possible and the promise of full duplex operation. It aligns with the parallel 3GPP evolution of spectrum increases from low-band carriers to adding mid- and high-band carriers, and where the uplink/downlink performance split is customer selected to address traffic demands.

During this evolution of standards and chipset evolutions, cable networks have integrated and delivered support for legacy TV, Digital Video, FM radio, transmission control protocol (TCP)-IP, IP Telephony, LAN/WAN switches and gateways, Wi-Fi, Streaming Services, Bluetooth, etc. This evolution of integration of various communication technologies has arguably included all wired and wireless services used by home and businesses.

The only exception to this DOCSIS evolution is 3GPP radio access network (RAN) technology such as second, third and fourth generation (2G, 3G, 4G), Internet of things (IoT), and 5G/NR. None of this technology has been integrated into cable networks or into the cable modems (CM) that reside in homes and businesses. This divergence is due in part to IPR—intellectual property rights but is largely a result of differences in wireless access paradigms.

DOCSIS consumer premises equipment (CPE) wireless access is based on the Institute of Electrical and Electronics Engineers IEEE 802.11 and is treated as one of many L2/L3 IP services. DOCSIS CPE are shipped with an integrated Wi-Fi medium access control (MAC)+PHY(sical) radio having an Ethernet IP connection via DOCSIS. Apart from offering QoS to improve streaming services, DOCSIS CPE are shipped with a fixed Wi-Fi solution capable of multiple input multiple output (MIMO), but unable to perform beamforming. CPE functionality is defined by hardware release and remains unchanged while the industry evolves with more advanced chipsets with beamforming for greater reach and throughput performance. DOCSIS CPE functions are therefore fixed and cannot be upgraded with new software releases. DOCSIS wireless features are static until customers upgrade their CPE every several years.

Cellular 4G/5G wireless features are based on an upgradable RAN platform. Software upgrades may be available quarterly with interspersed maintenance releases to ensure that the network is operating with common, up-to-date functionality and device interworking. This level of programmability comes at a cost of massively parallel digital signal processing computing functionality of the 5G base station (gNB) baseband units to the programmable MAC+PHY elements of the Radio Access Network. This programmable architecture ensures that the entire 4G/5G network is operating on the same software release, ensuring consistent network and device level interworking.

CableLabs position (https://www.cablelabs.com/10g/5g) on 3GPP 5G states that “the latest DOCSIS 3.1 standard enables cable operators to support all 5G requirements. The DOCSIS specification was recently upgraded to enable cable networks to provide mobile wireless backhaul services more effectively. This will support an increasing number of small cell architectures and 5G.”

This position is only valid for the case of cellular backhaul, intended mostly for small cells or picocells. Low Latency DOCSIS (LLD) introduces link monitoring capabilities required by network operators to manage the link “A” between the 3GPP Evolved Packet Core (EPC) network and the cellular operator's Pico/Micro radio base station (RBS) (gNB) radio equipment. Prior to LLD, DOCSIS was a best effort, unmanaged connectivity technology and virtually impractical for cellular backhaul transport which demands performance metrics for all network connectivity solutions. Interface “A” traditionally used telecom circuits such as a T1/E1, evolving to higher bandwidths over time. However, in all cases, this interface included performance metrics (PMs) and reliability service level agreements. Therefore, LLD is intended to support small cells such as micro-RBS and pico-RBS.

With typical published latencies of 2 ms (minimum) and 10 ms (typical), LLD technology is well suited for the delay requirements of interface “A”, but cannot support the latency requirements for the distributed radio access network (RAN) architectures employed in macro RBS deployments.

Macro RBS employ distributed architectures with network node functions split into radio equipment control (eREC) and radio equipment (eRE), as shown in FIG. 3.

The Common Public Radio Interface (CPRI) defines the connection between eREC and eRE. CPRI is a serial interface operating from 614.4 Mbit/s with 8B/10B line coding to 10137.6 Mbit/s with 64B/66B line coding, with proprietary extensions to higher bit rates. CPRI is typically an optical circuit-based technology to carry physical (PHY) layer radio signals from interface “B” to “C.”

The eCPRI Transport Network V1.2 (2018-06-25)—“Common Public Radio Interface: Requirements for the eCPRI Transport Network”, specifies requirements for packetized CPRI over an Ethernet network. In particular, this specification defines transport latencies between eREC and eRE ranging from an ultra-low one-way frame delay latency class of 25 μs to large latency installations with 500 μs. Low latency is desired for both functional operation and performance. Customers typically demand low latencies to maximize throughput performance. However, for rural deployments, customers often accept higher latencies with associated reductions in throughput performances. High latencies also require specialized radio configurations which may not be compatible with lower latency operation. Some 5G TDD configurations are only possible with low latency CPRI connectivity. Table I shows delay performance limits for different latency classes.

TABLE I

| | Maximum | | |
|---|---|---|---|
| Latency | One-Way Frame | | |
| Class | Delay Performance | | Use Case |
| High25 | 25 | microseconds | Ultra-low latency performance |
| High100 | 100 | microseconds | For full E-UTRA or NR performance |
| High200 | 200 | microseconds | For installations where the lengths of |
| | | | fiber links are in the 40 km range |
| High500 | 500 | microseconds | Large latency installations |

The delays specified in the eCPRI requirements specification account for signal propagation up to a reach of 40 km, commonly used as the limit for CPRI reach. A 40 km “speed of light” propagation introduces a one-way latency of 200 μs (400 μs round-trip) assuming a fiber with propagation velocity=0.67c or 5 μs/km. High latency classes, while specified, are intended for remote locations where fiber backhaul distances are >40 km. In these locations, radio timing must be modified, reducing overall throughput performance.

In summary, the current cable networks architecture, with millisecond latencies is well suited for the delay requirements of interface “A” but does not meet eCPRI requirements for the distributed radio access network (RAN) architectures employed in macro RBS deployments.

A known architecture of macro radio base station (RBS) deployments is shown in FIG. 4. FIG. 4 is a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of radio base stations 16a, 16b, 16c (referred to collectively as radio base stations 16), such as NBs, eNBs, gNBs or other types of wireless access points, each defining a corresponding coverage area 18a, 18b, 18c (referred to collectively as coverage areas 18). Each radio base station 16a, 16b, 16c is connectable to the core network 14 over a wired or wireless connection 20. A first wireless device (WD) 22a located in coverage area 18a is configured to wirelessly connect to, or be paged by, the corresponding radio base station 16a. A second WD 22b in coverage area 18b is wirelessly connectable to the corresponding radio base station 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding radio base station 16. Note that although only two WDs 22 and three radio base stations 16 are shown for convenience, the communication system may include many more WDs 22 and radio base stations 16.

Also, it is contemplated that a WD 22 can be in simultaneous communication and/or configured to separately communicate with more than one radio base station 16 and more than one type of radio base station 16. For example, a WD 22 can have dual connectivity with a radio base station 16 that supports LTE and the same or a different radio base station 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. This connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

Example implementations, in accordance with an embodiment, of the WD 22 and radio base station 16 discussed in the preceding paragraphs will now be described with reference to FIG. 5. The communication system 10 includes a radio base station 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the radio base station 16. The radio interface 62 may be formed as or may include, for example, one or more RF transmitters, one or more RF receivers, and/or one or more RF transceivers. The radio interface 62 (or the processing circuitry 68) may typically have a beamformer 66 that maps a set of signals to be transmitted to the WDs 22 to a set of antennas so as to cause the antennas to radiate beams of energy over the air in the directions of the WDs 22. In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the radio base station 16 further has software 74 stored internally in, for example, memory 72, or stored in external memory (e.g., database, storage array, network storage device, etc.) accessible by the radio base station 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to radio base station 16.

The communication system 10 further includes the WD 22 already referred to. The WD 22 may have hardware 80 that may include a radio interface 82 configured to set up and maintain a wireless connection 64 with a radio base station 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

One proposed architecture includes a converged network with an LTE/DOCSIS equality as shown in FIG. 6. The architecture only conceived of integrating the LTE eNB with the DOCSIS Remote Node. The architecture employed shared optical fiber interfaces and time interleaved LTE/DOCSIS quadrature amplitude modulated (QAM) symbols into a common inverse Fast Fourier Transform (IFFT)/Fast Fourier Transform (FFT) module to feed two separate front ends, as shown in FIG. 7. It did not address the ability to distribute LTE signals to each residence/business. Further, the above-referenced paper did not consider the strict Baseband (eREC) to Radio (eRE) timing requirements which cannot be met.

The above-referenced proposal also did not discuss the significant development effort and cost necessary to implement such a radically divergent architecture. Product development teams generally follow an evolutionary model as a cost-effective and expedient path to deliver new functionality. Only rarely are revolutionary paths taken. This unified proposal is considered revolutionary and therefore would not be adopted.

LLD has also been proposed for “Mobile Xhaul” to enable operators to carry mobile traffic across the DOCSIS network. The focus of this effort is to provide connectivity for small cells without requiring cellular operators (or cable operators) to install new fiber.

Work has been done with the O-RAN (Open RAN) alliance to study and define network improvements to deliver support for the A1 and E2 O-RAN interfaces through the Cooperative Transport Interface (CTI) initiative. While this effort will likely lead to a level of integration between Cable and Cellular networks, it does not address the timing sensitive network of the eREC (Baseband or Digital Unit) to eRE (i.e. Radio Equipment or Radio Unit).

The Distributed Access Architecture (DAA), as shown in FIG. 8, has been proposed as the evolution to support all network requirements for DOCSIS as it transforms into the next generation. DAA transforms the hybrid-fiber coax Centralized Access Architecture (I-CCAP) by separating the MAC/PHY elements into a CCAP MAC CORE with P-PHY-NODEs. While this split aligns the DOCSIS evolution to the path already taken by 3GPP with an eREC/eRE, it only addresses architectural deficiencies associated with the centralized CMTS MAC/PHY. It does not address fronthaul delay/latency and timing issues blocking the DOCSIS network from a complete transformation to support the 5G macro distributed architecture.

Existing cable network technology has several problems which limit 5G/NR for macro RBS with distributed radio equipment and distributed remote radio antenna applications: no CPRI (eREC/eRE) Support; and No Timing and Synchronization.

No CPRI Support:

The DOCSIS Reference Architecture (PHY V3.1 Spec., Section 1.2.5) defines the Core Network Cable Management Termination System (CMTS) and the Cable MODEM (CM) Customer Premises Equipment (CPE). Low Latency DOCSIS (LLD) is enabled through the Downstream External PHY Interface (DEPI) to monitor performance metrics (PMs) for this interface. LLD achieves latencies in the 2 millisecond range and cannot be used for CPRI transport. FIG. 9 is an illustration of a DOCSIS reference architecture.

No Timing and Synchronization:

The “Data-Over-Cable Service Interface Specifications DOCSIS® 3.1; MAC and Upper Layer Protocols Interface Specification; CM-SP-MULPIv3.1-120-200407 (Jul. 4, 2020)” describes DOCSIS Time Protocol (DTP) as “a set of techniques coupled with extensions to the DOCSIS signaling messages” to be optionally implemented in both the CMTS and CM. This standard suggests that the “CMTS is either self-synchronized or is synchronized to an external source” and provides examples of potential external sources which may be used including “IEEE1588-2008, Synchronous Ethernet (SyncE), DOCSIS Timing Interface (DTI), Global Positioning System (GPS), Network Time Protocol (NTP), or some combination of these protocols.”

It is well understood by 5G equipment manufacturers that timing and synchronization is a core functionality of network design and not an optional capability. It is a functionality built into every chipset and every interface and has extensive software support.

### SUMMARY

Some embodiments advantageously provide methods and network nodes for a hybrid DOCSIS-5G NR system.

In some embodiments, an integration of DOCSIS with a radio access technology architecture is disclosed. In some embodiments, a hybrid DOCSIS-4G/5G implementation overlays time sensitive 4G and/or 5G functionality on DOCSIS network elements and interfaces to bypass and/or overcome known limitations and enable a viable 4G or 5G network right to the edge of the DOCSIS network. The disclosed DOCSIS-4G/5G provides high performance 5G service inside multiple residences or businesses, each already served with DOCSIS data, all aggregated and coordinated by a network node co-sited with the DOCSIS Remote PHY node.

In some embodiments, the MHAv2 Reference Architecture is enhanced with 4G and/or 5G network elements and interfaces focusing on CPRI transport, synchronization, distribution and radio timing. These key areas ensure that the overlay network appears as a managed part of the DOCSIS network, while introducing 4G/5G specific functionality for delivering mobility services.

Some embodiments enable customers to continue to enjoy the capabilities and services offered by their cable operators, all of which are based on legacy DOCSIS CPE. As such, some embodiments provide a means for cable operators to enhance their CPE offering with a major new suite of 4G and/or 5G services while continuing planned and evolutionary DOCSIS features.

Some embodiments are scalable, with increasing levels of 4G/5G functionality and throughput. For example, a base offering could deliver a 2×20 MHz time division duplex (TDD) 5G carrier delivered to homes in a neighborhood. Customers who signed for the service would suddenly have excellent 5G reception at home and even seamlessly throughout the neighborhood empowering them to have mobile voice and data on their cellular devices, augmenting their current home-based Wi-Fi network.

According to one aspect, a core node is configured to communicate with a remote node via an optical fiber link the remote node being configured to communicate with consumer premises equipment, CPE via a cable link. The core node includes: a converged cable access platform, CCAP, core configured to provide data-over-cable services to the CPE via the optical fiber link; and a wireless core in communication with the CCAP core and configured to provide wireless communication system services to the CPE via the CCAP core.

According to this aspect, in some embodiments, the wireless communication system services include at least one of Third Generation Partnership Project (3GPP) New Radio (NR) services, 3GPP Long Term Evolution (LTE) services and Wi-Fi services. In some embodiments, the wireless core includes a user plane unit and a control plane unit configured to communicate with the remote node via tunnels to provide the wireless communication system services. In some embodiments, the tunnels include an Ethernet switch of the CCAP core. In some embodiments, the tunnels include a remote PHY pseudowire, PW, of the CCAP core. In some embodiments, the tunnels include an upstream external physical interface, UEPI, and a downstream external physical interface, DEPI. In some embodiments, the wireless core includes a serving gateway and a mobile management entity, MME, configured to communicate with the remote node via tunnels to provide the wireless communication system services.

According to another aspect a method in a core node configured to communicate with a remote node via an optical fiber link the remote node being configured to communicate with consumer premises equipment, CPE via a cable link, is provided. The method includes: providing data-over-cable services to the CPE via a converged cable access platform, CCAP, core. The method also includes providing wireless communication system services to the CPE via a wireless core in communication with the CCAP core the wireless communication services being provided to the CPE via of the CCAP core

According to this aspect, in some embodiments, the wireless communication system services include at least one of Third Generation Partnership Project (3GPP) New Radio (NR) services, 3GPP Long Term Evolution (LTE) services and Wi-Fi services. In some embodiments, the wireless communication system services are carried over tunnels between a user plane unit and a control plane unit of the wireless core and the remote node. In some embodiments, the tunnels include an Ethernet switch of the CCAP core. In some embodiments, the tunnels include a remote PHY pseudowire, PW, of the CCAP core. In some embodiments, the tunnels include an upstream external physical interface, UEPI, and a downstream external physical interface, DEPI. In some embodiments, the wireless communication system services are carried over tunnels between a serving gateway and a mobile management entity, MME, of the wireless core and the remote node.

According to yet another aspect, a remote node is configured to communicate with a core node via an optical fiber link, the remote node further being configured to communicate with consumer premises equipment, CPE via a cable link. The remote node includes: R-PHY equipment configured to provide data-over-cable services to the CPE; and radio equipment in communication with the R-PHY equipment and configured to provide wireless communication system services to the CPE via the R-PHY equipment.

According to this aspect, in some embodiments, the wireless communication system services include at least one of Third Generation Partnership Project (3GPP) New Radio (NR) services, 3GPP Long Term Evolution (LTE) services and Wi-Fi services. In some embodiments, providing the wireless communication system services includes processing wireless communication system data carried in part over an over-the-air radio frequency, RF, link via of radio base station equipment. In some embodiments, providing the wireless communication services includes communicating with a remote radio unit of the CPE via a tunnel. In some embodiments, the tunnel includes an Ethernet switch of the R-PHY equipment.

According to another aspect, a method in a remote node configured to communicate with a core node via an optical fiber link the remote node further being configured to communicate with consumer premises equipment, CPE via a cable link is provided. The method includes: providing data-over-cable services to the CPE via R-PHY equipment The method also includes providing wireless communication system services to the CPE via radio equipment in communication with the R-PHY equipment the wireless communication system services being provided to the CPE via the R-PHY equipment.

According to this aspect, in some embodiments, the wireless communication system services include at least one of Third Generation Partnership Project (3GPP) New Radio (NR) services, 3GPP Long Term Evolution (LTE) services and Wi-Fi services. In some embodiments, providing the wireless communication system services includes processing wireless communication system data carried in part over an over-the-air radio frequency, RF, link via of radio base station equipment. In some embodiments, providing the wireless communication services includes communicating with a remote radio unit of the CPE via a tunnel. In some embodiments, the tunnel includes an Ethernet switch of the R-PHY equipment.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a cable network interface between content sources and end devices;

FIG. 2 is wireless communication system delivering Internet content to a radio base station;

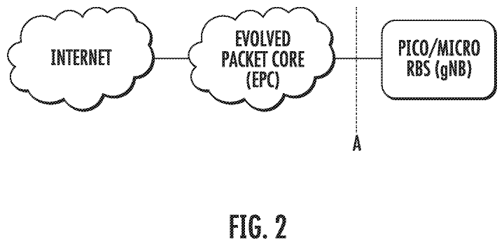

FIG. 3 is a wireless communication system exhibiting latency over a transport network between radio control equipment (eREC) and radio equipment (eRE);

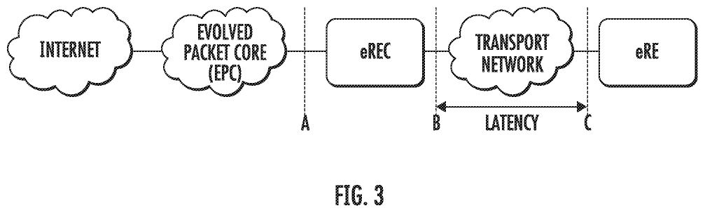

FIG. 4 is a schematic diagram of an example network architecture illustrating a communication system connected via an intermediate network to a host computer according to the principles in the present disclosure;

FIG. 5 is a block diagram of a radio base station in communication with a wireless device over an at least partially wireless connection according to some embodiments of the present disclosure;

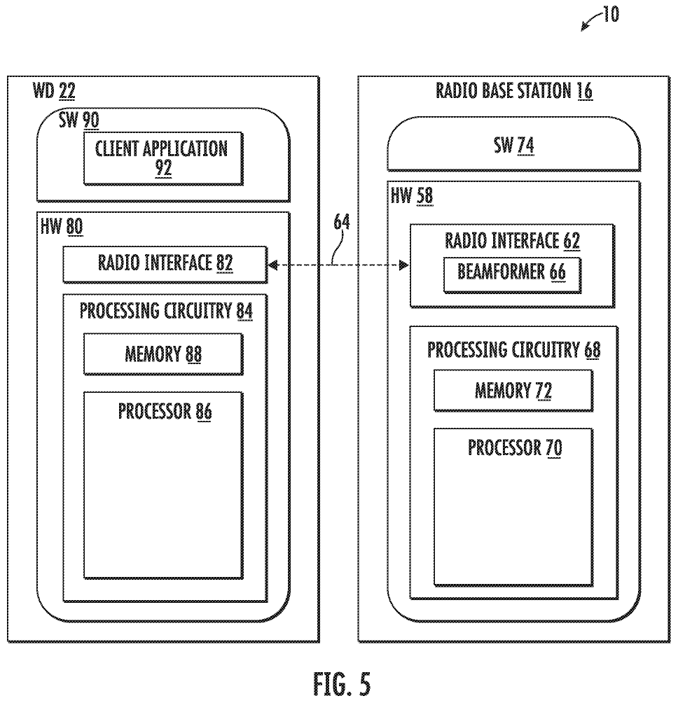

FIG. 6 is an illustration of an architecture combining Cable and LTE functionality;

FIG. 7 is an illustration of an integration of an LTE eNB with a DOCSIS remote node;

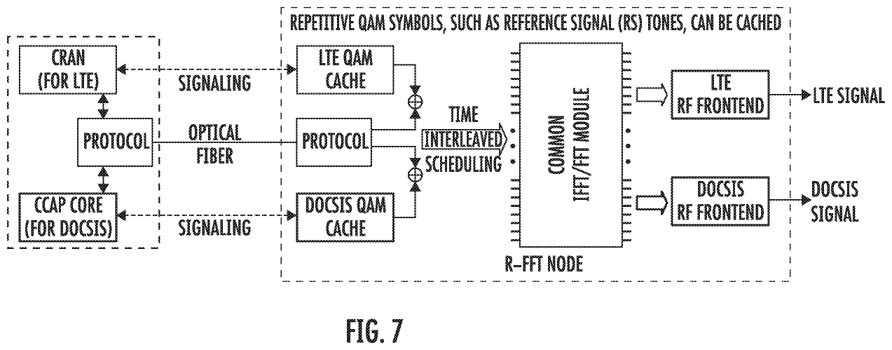

FIG. 8 is an illustration of a distributed access architecture;

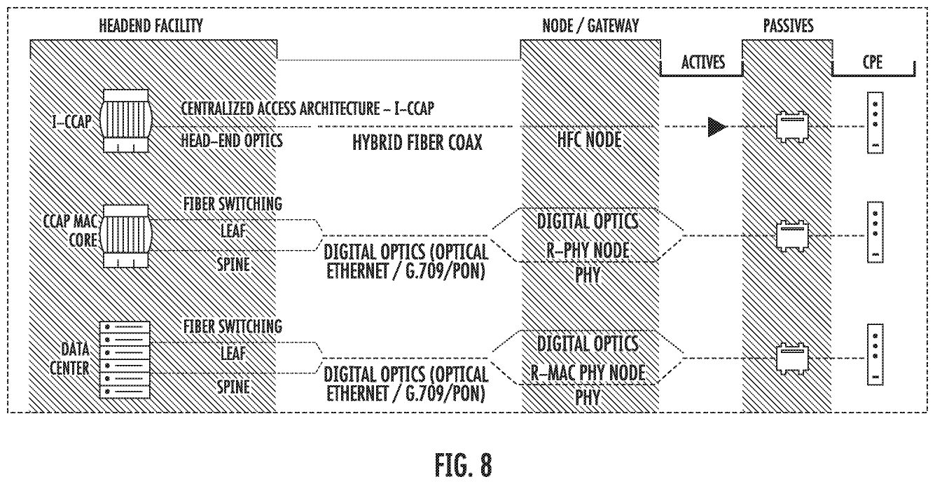

FIG. 9 is an illustration of a DOCSIS reference architecture;

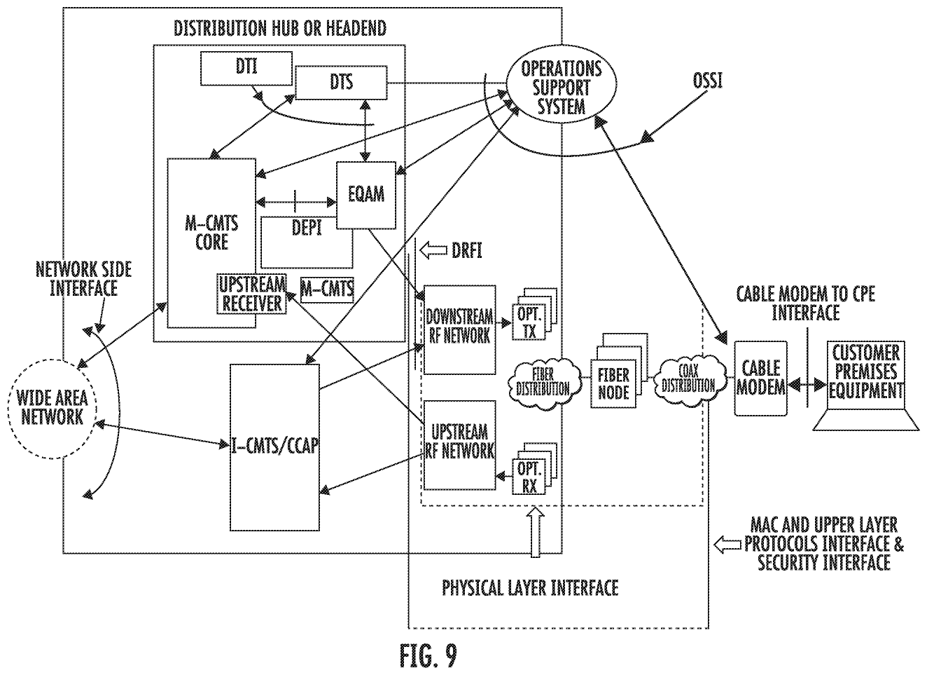

FIG. 10 is a DOCSIS DAA CCAP architecture;

FIG. 11 is a block diagram of a CCAP+EPC core and an R-PHY+radio base station with 4G radio equipment;

FIG. 12 is a block diagram of a CCAP+5G core and an R-PHY+radio base station with 5G radio equipment;

FIG. 13 is an illustration of tunnels between a CCAP+EPC core and an R-PHY+radio base station with 4G radio equipment;

FIG. 14 is an illustration of tunnels between a CCAP+5G core and an R-PHY+radio base station with 5G radio equipment;

FIG. 15 is a block diagram of an example core node configured to implement CCAP+wireless core functionality;

FIG. 16 is a block diagram of an example remote node configured to implement R-PHY+radio base station functionality;

FIG. 17 is a flowchart of an example process in a core node in a hybrid DOCSIS-wireless system;

FIG. 18 is a flowchart of an example process in a remote node for a hybrid DOCSIS-wireless system;

FIG. 19 is a flowchart of another example process in a core node in a hybrid DOCSIS-wireless system;

FIG. 20 is a flowchart of another example process in a remote node in a hybrid DOCSIS-wireless system;

FIG. 21 is an illustration of a DEPI port connected to an Ethernet switch with the R-PHY;

FIG. 22 is an illustration of internal components of the R-PHY having a fast path queue for MPEG video;

FIG. 23 is an illustration of an optical node employing signal processing with combiner, gain control, tilt control and amplification of a signal before duplexing the signal onto an HFC; and

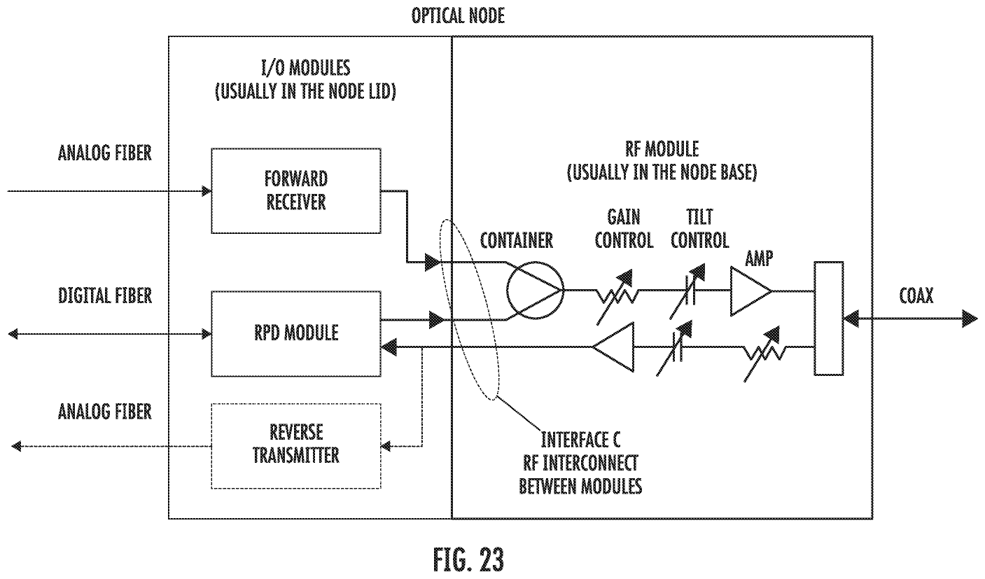

FIG. 24 is an illustration of transmitting a double symbol demodulation reference signal (DMRS).

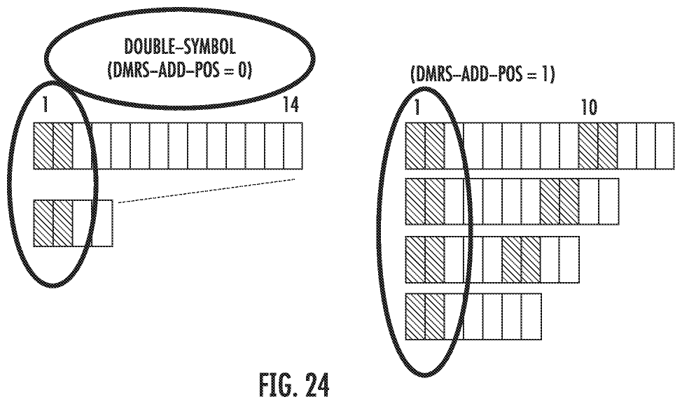

### DETAILED DESCRIPTION

Before describing in detail example embodiments, it is noted that the embodiments reside primarily in combinations of apparatus components and processing steps related to a hybrid DOCSIS-5G NR system.

Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “radio base station” used herein can be any kind of radio base station comprised in a radio network which may further comprise any of a base station (BS), radio base station, base transceiver station (BTS), base station controller (BSC), radio network controller (RNC), gNode B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide a hybrid DOCSIS-5G NR system providing physical separation between a CCAP core and a remote PHY (R-PHY) device. In some embodiments, the CCAP core is located with processing circuitry implementing some wireless core functionality and the R-PHY is located with processing circuitry implementing some radio base station functionality.

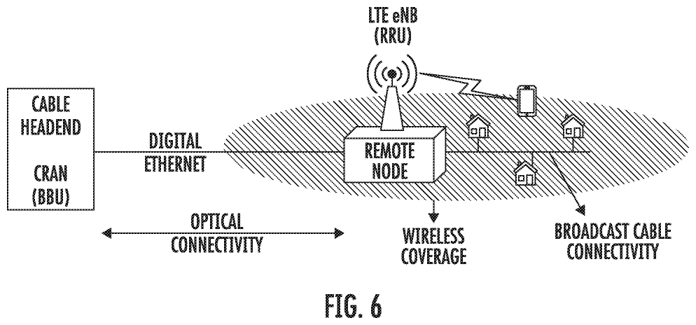

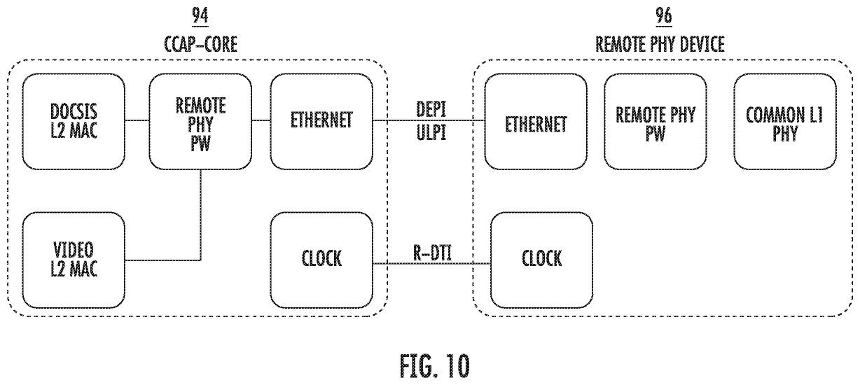

Referring again to the drawing figures where like reference designators refer to like elements, FIG. 10 shows a known DOCSIS DAA CCAP architecture. FIG. 10 is from Section 5.5, FIG. 6 of the Remote PHY Specification [ref: CM-SP-R-PHY-I14-200323]. This architecture includes a CCAP core 94 and an R-PHY device 96. The CCAP core 94 may be located at the cable head end or central office from which fiber is delivered into neighborhoods to R-PHY devices 96. Enhancements to the architecture of FIG. 10 are disclosed herein.

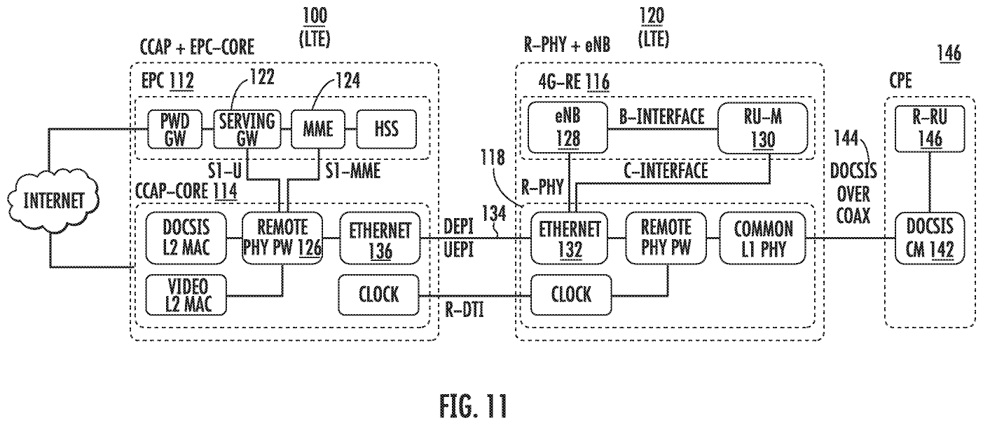

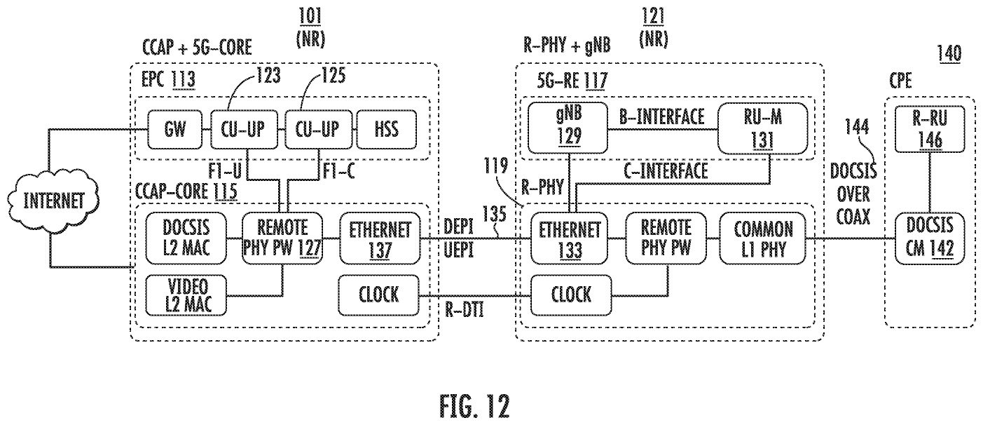

FIG. 11 is a block diagram of an example CCAP+EPC core (herein referred to as an LTE core node 100) and an R-PHY+eNB (herein referred to as an LTE remote node 120). The LTE core node 100 includes an evolved packet core (EPC) 112 and a CCAP core 114. The LTE remote node 120 includes 3GPP 4G (4G) radio equipment 116 and R-PHY equipment 118. A similar topology is shown in FIG. 12, which is a block diagram of a CCAP+5G core (herein referred to as an NR core node 101) and an R-PHY+gNB (herein referred to as an NR remote node 121). The NR core node 101 includes a 5G core 113 and a CCAP core 115. The NR remote node 121 includes 5G radio equipment 117 and the R-PHY equipment 119. The CCAP core 114 may be the same as, or different than, the CCAP core 115. Similarly, the R-PHY equipment 118 may be the same as, or different than, the R-PHY equipment 119.

The CCAP core 114, 115 may be located in a cable head end or central office and provide DOCSIS-compliant delivery of data-over-cable services, including Internet, cable television and voice over Internet protocol (VoIP) service. Similarly, the R-PHY equipment 118, 119 may be located in proximity to CPE 140 in a neighborhood or business district, for example, and further the provision of DOCSIS-compliant delivery of data-over-cable services.

The functionality of the 4G EPC 112 and the 5G core 113 may be combined or coexist in a same location such as the cable central offices. Note also, that the functionality of the 4G remote node 120 and the NR remote node 121 may be combined or coexist in a same location such as in a location in a neighborhood closer to the CPE than the core node 100, 101. The functionality of the 4G EPC 112 and/or the functionality of the 5G core 113 may include processing and routing communications between cellular phones and, for example, other cellular phones or a landline phone or an Internet phone or Internet server. The content of such communications may include voice, video and data. Similarly, the radio equipment 116, 117 includes radio base station equipment to provide 4G and/or 5G base station functionality to further the processing and routing of cellular communications and/or communications in an unlicensed spectrum.

Note that embodiments are not limited to LTE and NR, but may include other technologies for providing wireless communication system services, such as Wi-Fi. For example, the NR core node and NR remote node may be replaced or upgraded to 6^{th} Generation (6G) wireless communications standards now being developed. As noted, upgrading to new and different radio standards may be done, at least in part, remotely by software upgrades. An entire infrastructure exists for performing such upgrades, and 3GPP standards are developed to facilitate such upgrades. Wireless communication services include cellular radio services, and more generally include transmission and reception of radio signals over the air (OTA). Therefore, references to a core node 100, 101 are not limited to core nodes having 4G wireless communications technology or 5G wireless communications technology.

Referring to FIG. 11, the EPC 112 includes a serving gateway 122 and a mobile management entity (MME) 124 having functionality that includes functionality as may typically be found in an LTE network. For example, the serving gateway 122 may be configured to route and forward 4G wireless communication services traffic that is carried in part over an over-the-air radio frequency link. The MME 124 may be configured to process signaling traffic to control routing, for example, of the 4G wireless communications services traffic between one user at some remote location and a user at a consumer premise served by the CCAP core 114. The serving gateway 122 and the MME 124 may be configured to interface with a remote PHY pseudowire (PW) 126 of the CCAP core 114.

The 4G radio equipment 116 includes eNB radio base station equipment 128 and a radio unit multiplexer 130. The radio base station equipment 128 communicates with an Ethernet switch 132 (or other Ethernet interface device) which communicates over a optical fiber link 134 with a similar Ethernet switch or device 136 in the LTE core node 100. The radio base station equipment 128 communicates with the radio unit multiplexer 130 over the B interface. The radio unit multiplexer 130 multiplexes 4G data for different CPEs 140 via the C interface and the Ethernet switch 132.

Similarly, referring to FIG. 12, the 5G core 113 includes a user plane unit 123 and a control plane unit 125 having functionality that includes functionality as may typically be found in an NR network. For example, the user plane unit 123 may be configured to process 5G wireless communications user data (which has the content of communications between two end users, for example) that is carried in part over an over-the-air radio frequency link. The control plane unit 125 may be configured to process signaling traffic to control routing, for example, of the 5G wireless communications user data. The user plane unit 123 and the control plane unit 125 may be configured to interface with a remote PHY pseudowire (PW) 127 of the CCAP core 115.

The 5G radio equipment 117 includes gNB radio base station equipment 129 and a radio unit multiplexer 131. The radio base station equipment 129 communicates with an Ethernet switch 133 (or other Ethernet interface device) which communicates over an optical fiber link 135 with a similar router or device 137 in the NR core node 101. The radio base station equipment 129 communicates with the radio unit multiplexer 131 over the B interface. The radio unit multiplexer 131 multiplexes 5G data for different CPEs 140 via the C interface and the Ethernet switch 133.

The EPC core 112 and the 5G core 113 will be referred to herein as a wireless core 112, 113 to denote that they contain some or all of the functionality of wireless core network such as an EPC or 5G core of a respective LTE or NR wireless communication system. The combined CCAP core 114, 115 plus respective wireless core 112, 113 are referred to herein collectively as a core node 100, 101. The 4G and 5G radio equipment 116 and 117 may contain some or all of the functionality of an eNB and a gNB, respectively. The LTE remote node 120 and the NR remote node 121 are referred to herein collectively as a remote node 120, 121.

The core node 100, 101 and the remote node 120, 121 may be connected by an optical fiber link 134, which may support a downstream external PHY interface (DEPI) and an upstream external PHY interface (UEPI). The DOCSIS timing interface (DTI) may also be supported by the optical fiber link 134. As noted, although FIGS. 11 and 12 illustrate embodiments that implement LTE functionality and NR functionality, other radio access technologies (RAT), including existing RATs such as Wi-Fi and RATS to be developed in the future. In some embodiments, the 4G or 5G radio equipment 116, 117 includes functionality of the beamformer 66.

In some embodiments, the core node 100, 101 is located remote from the CPE 140 and the remote node 120, 121 is located in proximity to the CPE 140. Remote means further away from the CPE 140 than the remote node and in proximity means that the remote node is directly connected by the “last mile” to the CPE DOCSIS cable modem (CM) 142. The term “last mile” is a term of art that sometimes refers to a last link, (e.g., a coaxial cable link, 144) in a cable signal distribution network from the remote node 120, 121 to the CPE DOCSIS CM 142 of the CPE 140.

The proximity of the R-PHY 118, 119 to each CPE DOCSIS CM 142 location minimizes remote node 120 to R-RU 146 (Remote Radio Unit) latency over the last mile to the CPE DOCSIS CM 142. The R-RU (Remote Radio Unit) 146 may be added to a DOCSIS CPE 140 providing high performance 4G and/or 5G signals within each residence or business location.

Interfaces between the core nodes 100, 101 and remote nodes 120, 121 may be S1/X2 for 4G or NG/Xn for 5G, or in a virtualized 5G environment, may use the F1 packet data convergence protocol (PDCP) interface from the distributed unit (DU) component of the radio base station equipment (gNB) 129 to the centralized units (CU) which may include user and control plane units 123 and 125.

The interfaces may meet at least some distributed access architecture (DAA) requirements with an expected latency of 2 ms carried over L2TPv3 tunnels typical of an upstream external physical interface (UEPI) and a downstream external physical interface (DEPI). This latency, although perhaps significant for 3GPP transmissions, may not be as significant to real-time radio control.

Some embodiments include DOCSIS CCAP to R-PHY network latency improvements that focus on the downstream external PHY interface (DEPI), with the introduction of performance metrics to confirm compliance.

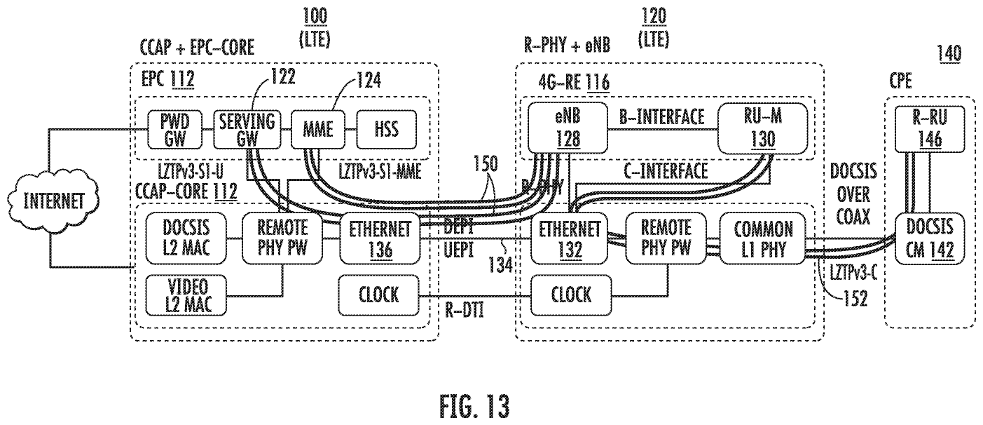

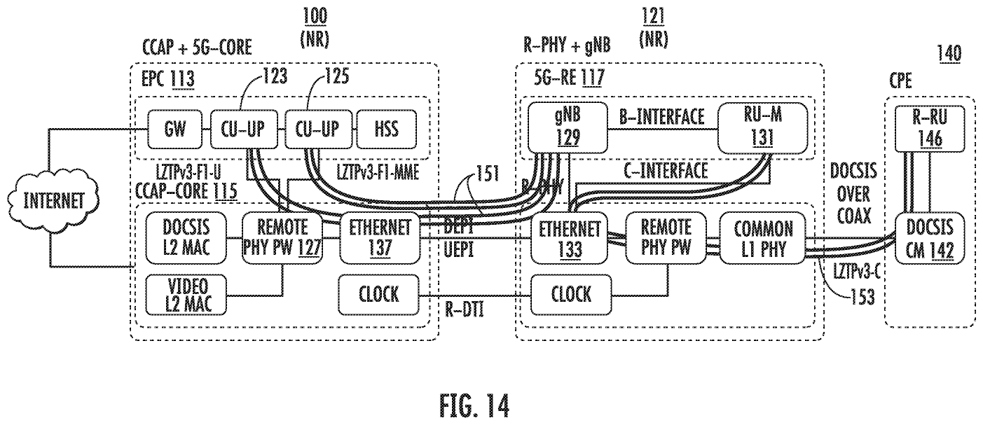

FIG. 13 shows an example implementation of L2TPv3 tunnels 150 between the serving gateway (GW) 122 and mobile management entity (MME) 124 elements of the core node 100 and the eNB radio base station equipment 128 of the remote node 120. These L2TPv3 tunnels may be configured to utilize the upstream and downstream external PHY interfaces (UEPI and DEPI) of the optical fiber link 134 and DEPI performance metrics may be monitored, for example, to ensure reliable low millisecond latency to a remote radio. FIG. 14 shows an example implementation of L2TPv3 tunnels 151 between user plane 123 and control plane 125 elements of the 5G core 113 of the core node 101 and the gNB radio base station equipment 129 of the remote node 121.

The radio base station equipment (eNB and/or gNB) 128, 129 to RU-M 130, 131 B-interface may use a CPRI stream, as commonly used between 4G/5G base stations and remote radio units 146. The RU-M 130, 131 may perform compression and multiplexing of the data to/from the R-RUs 146 via the C-Interface. The C-interface may use a compressed CPRI stream that is multiplexed with the DOCSIS user data to and from a DOCSIS CPE 140. Thus, the C-interface can be implemented as a CPRI and/or eCPRI.

The streams to each individual CPE 140 to the R-RU 146, may be managed in various ways by the RU-M 130, 131. In some embodiments, separate L2TPv3-C tunnels 152, 153 are used to transport the C-interface over the short distance between the RU-M 130, 131 and each R-RU 146 located within, for example, a 1-mile radius at the CPE 140. Note that although 1 mile is used here, a distance other than 1 mile that enables meeting specified latency requirements may be used. Measurements of R-PHY 118, 119 to DOCSIS CM 142 latency of 200 μs are both specified and have been demonstrated.

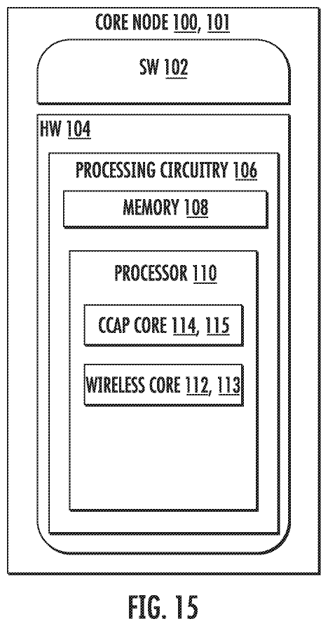

FIG. 15 is a block diagram of an example core node 100, 101 configured to implement functionality of the core nodes 100 and/or 101, described above. The core node 100, 101 may include software 102 that may include for example, user interface software, and executable program code to be executed in hardware 104 by processing circuitry 106. The processing circuitry 106 may include a memory 108 and a processor 110. In particular, in addition to or instead of a processor, such as a central processing unit, and memory, the processing circuitry 106 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 110 may be configured to access (e.g., write to and/or read from) the memory 108, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the core node 100, 101 further has software 102 stored internally in, for example, memory 108, or stored in external memory (e.g., database, storage array, network storage device, etc.) accessible by the core node 100, 101 via an external connection. The software 102 may be executable by the processing circuitry 106. The processing circuitry 106 may be configured to control any of the methods and/or processes described herein and/or to cause such methods, and/or processes to be performed, e.g., by the core node 100, 101. Processor 110 corresponds to one or more processors 110 for performing first network node functions described herein. The memory 108 is configured to store data, programmatic software code and/or other information described herein. In some embodiments, the software 102 may include instructions that, when executed by the processor 110 and/or processing circuitry 106, causes the processor 110 and/or processing circuitry 106 to perform the processes described herein with respect to core node 100, 101. For example, in some embodiments, the processor may perform some or all of the functions of a CCAP core 114, 115 and/or a wireless core 112, 113. Here, the CCAP core 114, 115 corresponds to the CCAP core shown in FIGS. 11-14. The wireless core 112, 113 may correspond to the wireless cores (EPC or 5G) shown in FIGS. 11-14.

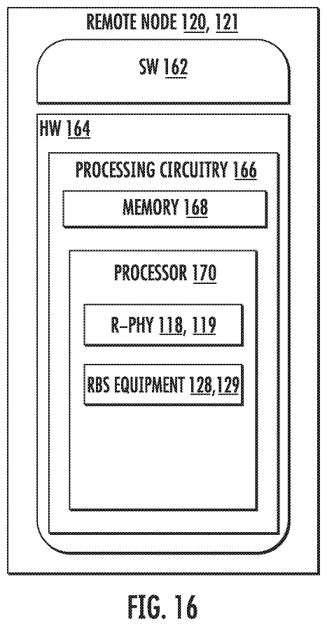

FIG. 16 is a block diagram of an example remote node 120, 121 configured to implement functionality of the remote nodes 120, 121, described above. The remote node 120, 121 may include software 162 that may include for example, user interface software, and executable program code to be executed in hardware 164 by processing circuitry 166. The processing circuitry 166 may include a memory 168 and a processor 170. In particular, in addition to or instead of a processor, such as a central processing unit, and memory, the processing circuitry 166 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 170 may be configured to access (e.g., write to and/or read from) the memory 168, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the remote node 120, 121 further has software 162 stored internally in, for example, memory 168, or stored in external memory (e.g., database, storage array, network storage device, etc.) accessible by the remote node 120, 121 via an external connection. The software 162 may be executable by the processing circuitry 166. The processing circuitry 166 may be configured to control any of the methods and/or processes described herein and/or to cause such methods, and/or processes to be performed, e.g., by the remote node 120, 121. Processor 170 corresponds to one or more processors 170 for performing second network node functions described herein. The memory 168 is configured to store data, programmatic software code and/or other information described herein. In some embodiments, the software 162 may include instructions that, when executed by the processor 170 and/or processing circuitry 166, causes the processor 170 and/or processing circuitry 166 to perform the processes described herein with respect to remote node 120, 121. For example, in some embodiments, the processor may include R-PHY 118, 119 and/or radio base station equipment 128, 129. The R-PHY 118, 119 corresponds to the R-PHY shown in FIGS. 11-14 and the radio base station equipment 128, 129 may correspond to the eNB shown in FIGS. 11 and 13 and/or the gNB shown in FIGS. 12 and 14. Functionality of the radio base station equipment 128, 129 may include beamforming, modulation, coding, amplification, frequency conversion, multiplexing and control signaling.

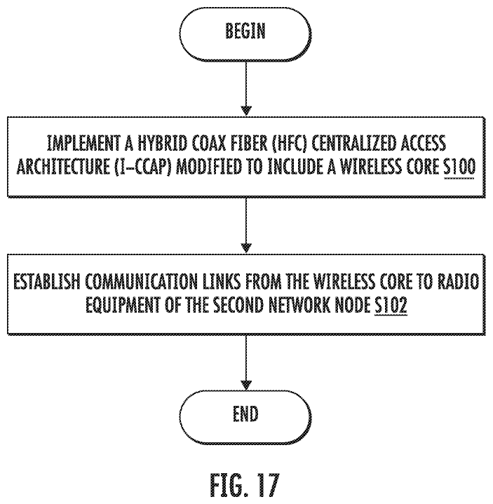

FIG. 17 is a flowchart of an example process in a core node 101 for a hybrid DOCSIS-5G NR system and/or a hybrid DOCSIS-4G LTE system. One or more blocks described herein may be performed by one or more elements of the core node 100, 101 such as by one or more of processing circuitry 106 (including the CCAP core 114, 115 and wireless core 112, 113) and processor 110. The core node 100, 101 such as via processing circuitry 106 and/or processor 110 is configured to implement a hybrid coax fiber (HFC) centralized access architecture (I-CCAP) modified to include a wireless core 112, 113 (Block S100). The process also includes establishing communication tunnels from the wireless core 112, 113 to radio base station equipment 128, 129 of the remote node (Block S102).

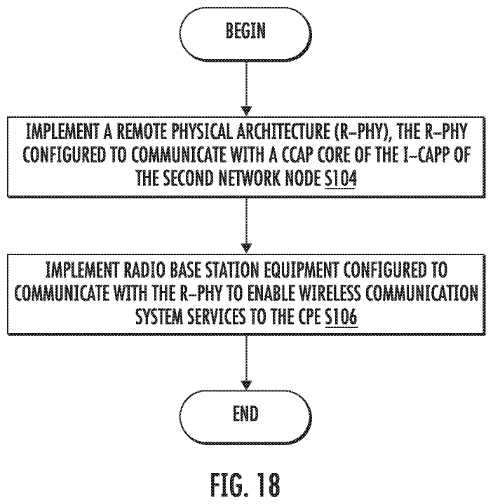

FIG. 18 is a flowchart of an example process in a remote node 120, 121 according to some embodiments of the present disclosure. One or more blocks described herein may be performed by one or more elements of remote node 120, 121, such as by one or more of processing circuitry 166 (including the R-PHY 118, 119 and radio base station equipment 128, 129), and processor 170. The remote node 120, 121 such as via processing circuitry 166 and/or processor 170 is configured to implement a remote physical architecture (R-PHY), the R-PHY 118, 119 configured to communicate with a CCAP core of the I-CAPP of the core node 100, 101 (Block S104). The process also includes implementing radio base station equipment 128, 129 configured to communicate with the R-PHY 118, 119 to enable delivery of wireless communication system services to the CPE 140 (Block S106).

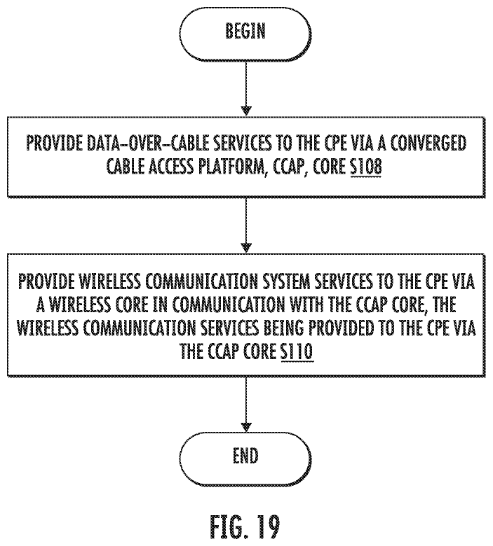

FIG. 19 is a flowchart of an example process in a core node 100, 101, configured to communicate with a remote node 120, 121 via an optical fiber link 134, 135, the remote node 120, 121 being configured to communicate with consumer premises equipment, CPE 140 via a cable link 144. The process may be performed by processing circuitry 106, including CCAP core 114, 115 and wireless core 112, 113. The process includes: providing data-over-cable services to the CPE 140 via a converged cable access platform, CCAP, core 114, 115 (Block S108). The process also includes providing wireless communication system services to the CPE 140 via a wireless core 112, 113 in communication with the CCAP core 114, 115, the wireless communication services being provided to the CPE 140 via of the CCAP core 114, 115 (Block S110).

In some embodiments, the wireless communication system services include at least one of Third Generation Partnership Project (3GPP) New Radio (NR) services, 3GPP Long Term Evolution (LTE) services and Wi-Fi services. In some embodiments, the wireless communication system services are carried over tunnels 151 between a user plane unit 123 and a control plane unit 125 of the wireless core 113 and the remote node 121. In some embodiments, the tunnels 151 include an Ethernet switch of the CCAP core 115. In some embodiments, the tunnels 151 include a remote PHY pseudowire, PW, 127 of the CCAP core 115. In some embodiments, the tunnels 151 include an upstream external physical interface, UEPI, and a downstream external physical interface, DEPI. In some embodiments, the wireless communication system services are carried over tunnels 150 between a serving gateway 122 and a mobile management entity, MME, 124 of the wireless core 112 and the remote node 120.

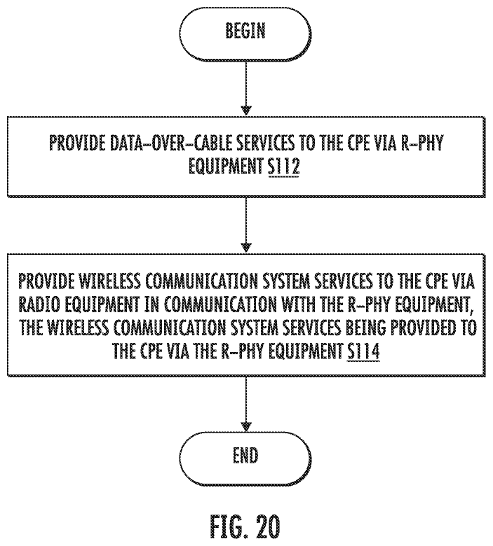

FIG. 20 is a flowchart of an example process in a remote node 120, 121 configured to communicate with a core node 100, 101 via an optical fiber link 134, 135, the remote node 120, 121 further being configured to communicate with consumer premises equipment, CPE 140 via a cable link 144. The process may be performed by processing circuitry 166, including R-PHY equipment 118, 119 and radio base station equipment 128, 129. The process includes: providing data-over-cable services to the CPE 140 via R-PHY equipment 118, 119 (Block S112). The process also includes providing wireless communication system services to the CPE 140 via radio equipment 116, 117 in communication with the R-PHY equipment 118, 119, the wireless communication system services being provided to the CPE 140 via the R-PHY equipment.

In some embodiments, the wireless communication system services include at least one of Third Generation Partnership Project (3GPP) New Radio (NR) services, 3GPP Long Term Evolution (LTE) services and Wi-Fi services. In some embodiments, providing the wireless communication system services includes processing wireless communication system data carried in part over an over-the-air radio frequency, RF, link via of radio base station equipment 128, 129. In some embodiments, providing the wireless communication services includes communicating with a remote radio unit 146 of the CPE 140 via a tunnel 152, 153. In some embodiments, the tunnel 152, 153 includes an Ethernet switch 132, 133 of the R-PHY equipment 118, 119.

The specification “Remote Downstream External PHY Interface Specification CM-SP-R-DEPI-I14-200323” states:
“in the absence of higher priority traffic, and regardless of the amount of lower priority traffic, the RPD [remote physical device] MUST forward isolated packets in each DEPI flow with a latency of less than 200 μs plus the delay of the inter-leaver.”

Section “6.1.4 Latency and Skew Requirements for DOCSIS Channels” subsection “6.1.4.1 Latency” provides a definition for this latency:
“For PSP DEPI DOCSIS sessions, latency is defined as the absolute difference in time from when the last bit of a DEPI packet containing the last bit of a single DOCSIS MAC frame enters the RPD DEPI port to the time that the first bit of the DOCSIS MAC frame exits the RPD RFI port. For D-MPT and MCM DEPI sessions, latency is defined as the absolute difference in time from when the last bit of a DEPI packet enters the RPD DEPI port to the time that the first bit of the first MPEG packet contained within said DEPI packet exits the RPD RFI port. At the RPD input, the last bit of the arriving DEPI packet is used because the RPD's Layer 2 interface (e.g., GigE or 10 GigE port) is to receive the entire packet before the RPD can begin processing.”

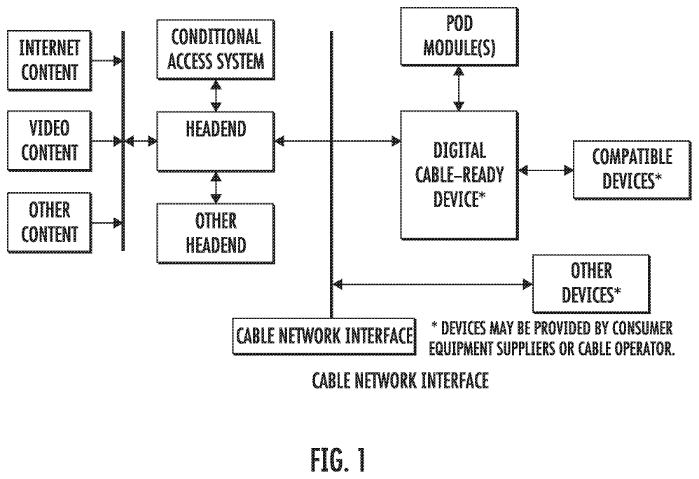

In the reference above, the DEPI port is connected to the Ethernet switch 132, 133 within the R-PHY 118, 119 which is the same point at which the XXX is connected. This is shown in FIG. 19, which is from FIG. 1 of “Remote PHY Specification; CM-SP-R-PHY-I14-200323.”

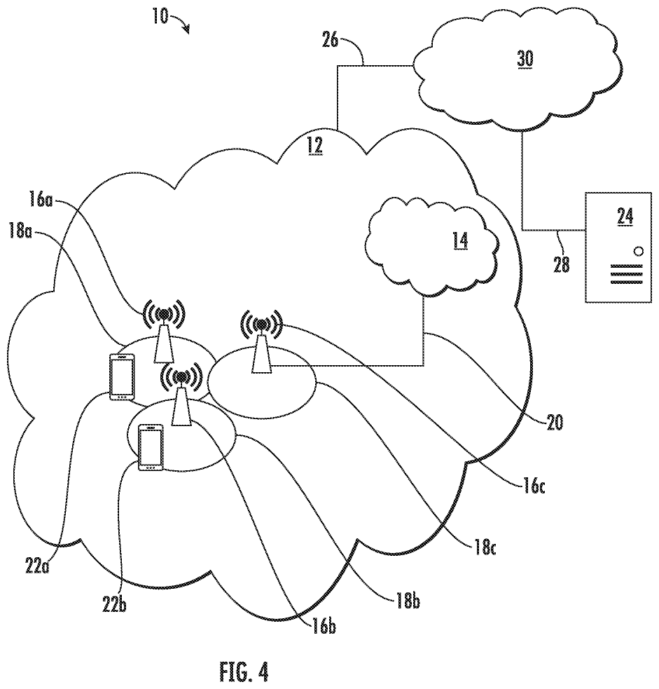

A more detailed view of the internals of the R-PHY 118, 119 shows a fast path queue for Moving Pictures Expert Group (MPEG) video, as shown below in FIG. 20, which is taken from FIG. 4 of “Downstream DOCSIS and Video R-PHY Block Diagram” [Remote Downstream External PHY Interface Specification CM-SP-R-DEPI-I14-200323].

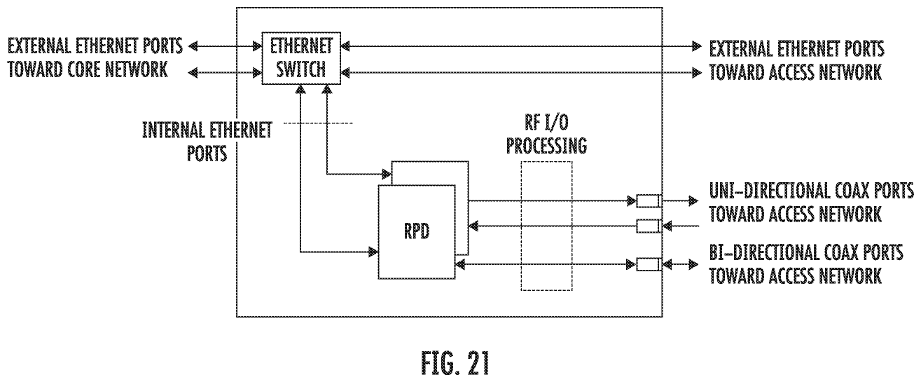

Latency after the R-PHY is expected to be negligible, as the subtending Optical Node shown in FIG. 21 may employ entirely analog signal processing, with combiner, gain control, tilt control, and amplification of the signal received from the optical fiber link 134 before duplexing it onto the coaxial cable link 144.

Achieving real-time performance may lead to a “Layer 2 Tunneling Protocol version 3” L2TPv3-C-Interface to be treated as a pseudo wire to be transparently forwarded as a Layer 2 frame over a Layer 3 network. L2TPv3-C-Interface packets may be assigned a 32-bit Session ID to be associated with a specific L2TPv3 S1-U or S1-MME flow from the EPC to various network node elements. Each flow may be marked with different Differentiated Services Code Points (DSCPs) to ensure high priority transport. Additionally, these packets may be transmitted in MPEG protocol transport (MPT) mode, each with a unique sub-header containing a sequence number for packet loss detection.

The resulting CPE 140 is then greatly simplified, combining the functions of DOCSIS CM 142 with an active R-RU 146. In some embodiments, the NR protocol may be modified to increase an amount of time available from 200 us to as much as 400 us, for example. This may be possible to achieve with only minor configuration changes to the NR protocol. For example, the WD uplink may be configured to transmit a double-symbol demodulation reference signal as the first symbol for each uplink (UL) transmission, to obtain an additional 33 us.

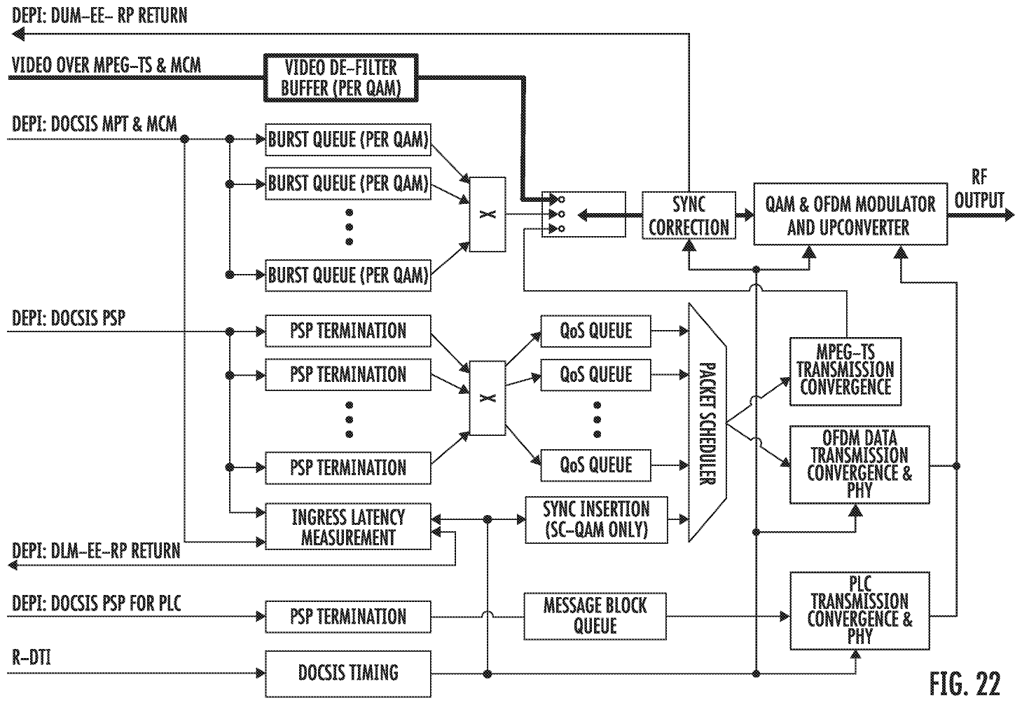

In some embodiments, a scheduler in the network node is configured to only schedule data in the first N-symbols and leave the last symbol empty. While this may not be possible with current system constants, it may provide additional microseconds of delay to carry RU to DOT data over a DOCSIS network without having to wait for improved DOCSIS latency specifications better than 200 μs. This is shown in FIG. 22.

Also, some improvements to the timing of the R-ANT “TRP” (transmit reference point) may be made. This is readily possible using proprietary radio interface based monitoring (RIBM) solutions within a DOCSIS neighborhood. The network node and RU-M could ultimately be implemented as modules within a GAP (Generic Access Platform) remote as being specified by Cable Labs and the Society of Cable Telecommunication Engineers (SCTE) to enable widespread deployment.

There may be an Intel link and/or an SCTE link. The R-RU 146 can be an integral part of next generation DOCSIS CPE 140, or an Ethernet add-on module.

Some embodiments may have one or more of the following advantages:
Leveraging existing DOCSIS network delivering a parallel 5G/NR overlay, which can be managed using current cable service providers network operations center (NOC);
Delivering 5G/NR services directly into buildings already being serviced by Cable Service Provider's DOCSIS ensuring very high performance radio frequency (RF) connectivity;
Augmenting, rather than replacing, Cable Service Provider's DOCSIS networks. In doing so, powerful value added 5G/NR features are delivered to current DOCSIS service plans, enabling mobile system operators (MSO) to offer higher end billing strategies;
Maintaining the centralized programmable nature of the 3GPP network, and in doing so, minimizing network costs, costs of feature development, and enabling compatibility of the DOCSIS network with the global mobile network; and/or Interfaces between the core and network nodes may be S1/X2 for 4G or NG/Xn for 5G, or in a virtualized 5G environment could use the F1 (PDCP) interface from the DU component of the second network node 120 to the centralized CU component.

According to one aspect, a core node 100, 101 is configured to communicate and interface with a remote node 120, 121, the remote node 120, 121 being configured to communicate with consumer premises equipment (CPE) 140. The core node 100, 101 includes processing circuitry 106 configured to: implement a hybrid coax fiber (HFC) centralized access architecture (I-CCAP) modified to include a wireless core 112, 113; and interface with the remote node 120, 121 to provide communication tunnels from the wireless core 112, 113 to radio base station equipment 128, 129 of the remote node 120, 121.

According to this aspect, in some embodiments, the communication tunnels connect a user plane and a control plane of the core node 100, 101 to a gNB of the remote node 120, 121. In some embodiments, the communication tunnels connect a serving gateway and a mobile management entity of the core node 100, 101 to an eNB of the second network node 120, 121. In some embodiments, the processing circuitry 106 is further configured to provide a timing reference to the remote node 120, 121. In some embodiments, the I-CCAP includes a DOCSIS-standards compliant CCAP core.

According to another aspect, a method is provided in a core node 100, 101 configured to communicate and interface with a remote node 120, 121, the remote node 120, 121 being configured to communicate with consumer premises equipment (CPE) 140. The method includes implementing a hybrid coax fiber (HFC) centralized access architecture (I-CCAP) modified to include a wireless core 112, 113. The method also includes establishing communication tunnels from the wireless core 112, 113 to radio base station equipment 128, 129 of the remote node 120, 121.

According to this aspect, in some embodiments, the communication tunnels connect a user plane and a control plane of the core node 101 to a gNB of the remote node 121. In some embodiments, the communication tunnels connect a serving gateway and a mobile management entity of the core node 100 to an eNB of the remote node 120. In some embodiments, the method further includes providing a timing reference to the remote node 120, 121. In some embodiments, the I-CCAP includes a DOCSIS-standards compliant CCAP core 114, 115.

According to yet another aspect, a remote node 120, 121 is configured to communicate and interface between a core node 100, 101 and consumer premises equipment (CPE) 140, the core node 100, 101 being configured to provide a hybrid coax fiber (HFC) centralized access architecture (I-CCAP) modified to include a wireless core 112, 113. The remote node 120, 121 comprises processing circuitry 166 configured to: implement a remote physical architecture (R-PHY) 118, 119, the R-PHY 118, 119 configured to communicate with a CCAP core 114, 115 of the I-CAPP of the core node 100, 101, and implement radio base station equipment 128, 129 configured to communicate with the R-PHY 118, 119 to enable delivery of wireless communication system services to the CPE 140. For example, in the case of 4G, the radio base station equipment 128 includes eNB functionality, and in the case of 5G, the radio base station equipment 129 includes gNB functionality.

According to this aspect, in some embodiments, the processing circuitry 166 is further configured to interface with the core node 100, 101 to provide communication tunnels from the wireless core 112, 113 of the core node 100, 101 to the radio base station equipment 128, 129. In some embodiments, the radio base station equipment 129 includes gNB radio base station equipment and the communication tunnels connect a user plane and a control plane of the core node 100, 101 to the gNB radio base station equipment. In some embodiments, the radio base station equipment 128 includes eNB radio base station equipment and the communication tunnels connect a serving gateway and a mobile management entity of the core node 100, 101 to the eNB radio base station equipment 128. In some embodiments, the processing circuitry 166 is further configured to receive a timing reference from the core node 100, 101. In some embodiments, the R-PHY is DOCSIS-standards compliant. In some embodiments, the processing circuitry 166 is further configured to implement a communication tunnel between a radio unit multiplexer of the radio base station equipment 128, 129 to a remote radio unit in the CPE via the R-PHY.

According to another aspect, a method is provided in a remote node 120, 121 configured to communicate and interface between a core node 100, 101 and consumer premises equipment (CPE) 140, the core node 100, 101 being configured to provide a hybrid coax fiber (HFC) centralized access architecture (I-CCAP) modified to include a wireless core 112, 113. The method includes: implementing a remote physical architecture (R-PHY), the R-PHY configured to communicate with a CCAP core 114, 115 of the I-CAPP of the core node 100, 101, and implementing radio base station equipment 128, 129 configured to communicate with the R-PHY to enable delivery of wireless communication system services to the CPE 140.

According to this aspect, in some embodiments, the method further includes interfacing with the core node 100, 101 to provide communication tunnels from the wireless core 112, 113 of the core node 100, 100 to the radio base station equipment 128, 129. In some embodiments, implementing the radio base station equipment 128, 129 further comprises implementing gNB functionality and wherein the communication tunnels connect a user plane and a control plane of the second network node to a gNB of the radio equipment. In some embodiments, implementing the radio base station equipment 128, 129 further comprising implementing an eNB and wherein the communication tunnels connect a serving gateway and a mobile management entity of the core node 100, 101 to an eNB of the radio base station equipment 128, 129. In some embodiments, the method further includes receiving a timing reference from the core node 100, 101. In some embodiments, the R-PHY is DOCSIS-standards compliant. In some embodiments, the method further includes implementing a communication tunnel between a radio unit multiplexer of the radio base station equipment 128, 129 to a remote radio unit in the CPE 140 via the R-PHY.

Some embodiments may include one or more of the following:

Embodiment A1. A first network node configured to communicate and interface with a second network node, the second network node being configured to communicate with consumer premises equipment (CPE), the first network node comprising processing circuitry configured to:
implement a hybrid coax fiber (HFC) centralized access architecture (I-CCAP) modified to include a wireless core; and
interface with the second network node to provide communication tunnels from the wireless core to radio base station equipment of the second network node.

Embodiment A2. The first network node of Embodiment A1, wherein the communication tunnels connect a user plane and a control plane of the first network node to gNB radio base station equipment of the second network node.

Embodiment A3. The first network node of Embodiment A1, wherein the communication tunnels connect a serving gateway and a mobile management entity of the first network node to eNB radio base station equipment of the second network node.

Embodiment A4. The first network node of any of Embodiments A1-A3, wherein the processing circuitry is further configured to provide a timing reference to the second network node.

Embodiment A5. The first network node of any of Embodiments A1-A4, wherein the I-CCAP includes a DOCSIS-standards compliant CCAP core.

Embodiment B1. A method in a first network node configured to communicate and interface with a second network node, the second network node being configured to communicate with consumer premises equipment (CPE), the method comprising:
implementing a hybrid coax fiber (HFC) centralized access architecture (I-CCAP) modified to include a wireless core; and
establishing communication tunnels from the wireless core to radio base station equipment of the second network node.

Embodiment B2. The method of Embodiment B1, wherein the communication tunnels connect a user plane and a control plane of the first network node to gNB radio base station equipment of the second network node.

Embodiment B3. The method of Embodiment B1, wherein the communication tunnels connect a serving gateway and a mobile management entity of the first network node to eNB radio base station equipment of the second network node.

Embodiment B4. The method of any of Embodiments B1-B3, further comprising providing a timing reference to the second network node.

Embodiment B5. The method of any of Embodiments B1-B4, wherein the I-CCAP includes a DOCSIS-standards compliant CCAP core.

Embodiment C1. A first network node configured to communicate and interface between a second network node and consumer premises equipment (CPE), the second network node being configured to provide a hybrid coax fiber (HFC) centralized access architecture (I-CCAP) modified to include a wireless core, the first network node comprising processing circuitry configured to:
implement a remote physical architecture (R-PHY), the R-PHY configured to communicate with a CCAP core of the I-CAPP of the second network node; and
implement radio base station equipment configured to communicate with the R-PHY to enable delivery of wireless communication system services to the CPE.

Embodiment C2. The first network node of Embodiment C1, wherein the processing circuitry is further configured to interface with the second network node to provide communication tunnels from the wireless core of the second network node to the radio base station equipment.

Embodiment C3. The first network node of Embodiment C2, wherein:
the radio base station equipment includes a gNB and the communication tunnels connect a user plane and a control plane of the second network node to a gNB of the radio base station equipment.

Embodiment C4. The first network node of Embodiment C1, wherein:
the receiving equipment includes an eNB and the communication tunnels connect a serving gateway and a mobile management entity of the second network node to an eNB of the radio base station equipment.

Embodiment C5. The first network node of any of Embodiments C1-C3, wherein the processing circuitry is further configured to receive a timing reference from the second network node.

Embodiment C6. The first network node of any of Embodiments C1-C4, wherein the R-PHY is DOCSIS-standards compliant.

Embodiment C7. The first network node of any of Embodiments C1-C6, wherein the processing circuitry is further configured to implement a communication tunnel between a radio unit multiplexer of the radio base station equipment to a remote radio unit in the CPE via the R-PHY.

Embodiment D1. A method in a first network node configured to communicate and interface between a second network node and consumer premises equipment (CPE), the second network node being configured to provide a hybrid coax fiber (HFC) centralized access architecture (I-CCAP) modified to include a wireless core, the method comprising:
implementing a remote physical architecture (R-PHY), the R-PHY configured to communicate with a CCAP core of the I-CAPP of the second network node; and
implementing radio base station equipment configured to communicate with the R-PHY to enable delivery of wireless communication system services to the CPE.

Embodiment D2. The method of Embodiment D1, further comprising interfacing with the second network node to provide communication tunnels from the wireless core of the second network node to the radio base station equipment.

Embodiment D3. The method of Embodiment D2, wherein implementing the receiving equipment further comprises implementing gNB functionality and wherein the communication tunnels connect a user plane and a control plane of the second network node to a gNB of the radio base station equipment.

Embodiment D4. The method of Embodiment D1, wherein implementing the radio base station equipment further comprising implementing an eNB and wherein the communication tunnels connect a serving gateway and a mobile management entity of the second network node to an eNB of the radio base station equipment.

Embodiment D5. The method of any of Embodiments D1-D3, further comprising receiving a timing reference from the second network node.

Embodiment D6. The method of any of Embodiments D1-D4, wherein the R-PHY is DOCSIS-standards compliant.

Embodiment D7. The method of any of Embodiments D1-D6, further comprising implementing a communication tunnel between a radio unit multiplexer of the radio base station equipment to a remote radio unit in the CPE via the R-PHY.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

Abbreviation Explanation
3GPP Thirds Generation Partnership Program
CA Carrier Aggregation
CPE Customer Premises Equipment
CRAN Centralized RAN
CU Centralized Unit
CMTS Cable Modem Termination System
CP Control Plane
CPRI Common Public Radio Interface
DAS Distributed Antenna System
DOCSIS Data over Cable Service Interface Specification
DU Distributed Unit
DRAN Distributed RAN
eCPRI evolved or enhanced CPRI
FE Front-End
HFC Hybrid Fiber Coax
IAB Integrated Access Backhaul
IF Intermediate Frequency
LTE Long term evolution
MIMO Multiple-input Multiple-output
MT Mobile Terminal
NR Next-generation Radio (5G)
OTA Over the Air
RIBS Radio-interface base-station sync, 3GPP 36.898
RF Radio Frequency
SU Single-User
UP User Plane

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A core node configured to communicate with a remote node via an optical fiber link, the remote node being configured to communicate with consumer premises equipment, CPE via a cable link, the core node comprising:
a converged cable access platform, CCAP, core configured to provide data-over-cable services to the CPE via the optical fiber link; and
a wireless core in communication with the CCAP core and configured to provide wireless communication system services to the CPE via the CCAP core.

2. The core node of claim 1, wherein the wireless communication system services include at least one of Third Generation Partnership Project (3GPP) New Radio (NR) services, 3GPP Long Term Evolution (LTE) services and Wi-Fi services.

3. The core node of claim 1, wherein the wireless core includes a user plane unit and a control plane unit configured to communicate with the remote node via tunnels to provide the wireless communication system services.

4. The core node of claim 3, wherein the tunnels include an Ethernet switch of the CCAP core.

5. The core node of claim 3, wherein the tunnels include a remote PHY pseudowire, PW, of the CCAP core.

6. The core node of claim 3, wherein the tunnels include an upstream external physical interface, UEPI, and a downstream external physical interface, DEPI.

7. The core node of claim 1, wherein the wireless core includes a serving gateway and a mobile management entity, MME, configured to communicate with the remote node via tunnels to provide the wireless communication system services.

8. A method in a core node configured to communicate with a remote node via an optical fiber link, the remote node being configured to communicate with consumer premises equipment, CPE via a cable link, the method comprising:
providing data-over-cable services to the CPE via a converged cable access platform, CCAP, core; and
providing wireless communication system services to the CPE via a wireless core in communication with the CCAP core, the wireless communication services being provided to the CPE via of the CCAP core.

9. The method of claim 8, wherein the wireless communication system services include at least one of Third Generation Partnership Project (3GPP) New Radio (NR) services, 3GPP Long Term Evolution (LTE) services and Wi-Fi services.

10. The method of claim 8, wherein the wireless communication system services are carried over tunnels between a user plane unit and a control plane unit of the wireless core and the remote node.

11. The method of claim 10, wherein the tunnels include an Ethernet switch of the CCAP core.

12. The method of claim 10, wherein the tunnels include a remote PHY pseudowire, PW, of the CCAP core.

13. The method of claim 10, wherein the tunnels include an upstream external physical interface, UEPI, and a downstream external physical interface, DEPI.

14. The method of claim 8, wherein the wireless communication system services are carried over tunnels between a serving gateway and a mobile management entity, MME, of the wireless core and the remote node.

15. A remote node configured to communicate with a core node via an optical fiber link, the remote node further being configured to communicate with consumer premises equipment, CPE via a cable link, the remote node comprising:
R-PHY equipment configured to provide data-over-cable services to the CPE; and
radio equipment in communication with the R-PHY equipment and configured to provide wireless communication system services to the CPE via the R-PHY equipment.

16. The remote node of claim 15, wherein the wireless communication system services include at least one of Third Generation Partnership Project (3GPP) New Radio (NR) services, 3GPP Long Term Evolution (LTE) services and Wi-Fi services.

17. The remote node of claim 15, wherein the radio equipment includes radio base station equipment configured to process wireless communication system data carried in part over an over-the-air radio frequency, RF, link.

18. The remote node of claim 15, wherein the radio equipment includes a radio unit multiplexer configured to communicate with a remote radio unit of the CPE via a tunnel to provide the wireless communication services.

19. The remote node of claim 18, wherein the tunnel includes an Ethernet switch of the R-PHY equipment.

20. A method in a remote node configured to communicate with a core node via an optical fiber link, the remote node further being configured to communicate with consumer premises equipment, CPE via a cable link, the method comprising:
providing data-over-cable services to the CPE via R-PHY equipment; and
providing wireless communication system services to the CPE via radio equipment in communication with the R-PHY equipment, the wireless communication system services being provided to the CPE via the R-PHY equipment.

21. The method of claim 20, wherein the wireless communication system services include at least one of Third Generation Partnership Project (3GPP) New Radio (NR) services, 3GPP Long Term Evolution (LTE) services and Wi-Fi services.

22. The method of claim 20, wherein providing the wireless communication system services includes processing wireless communication system data carried in part over an over-the-air radio frequency, RF, link via of radio base station equipment.

23. The method of claim 20, wherein providing the wireless communication services includes communicating with a remote radio unit of the CPE via a tunnel.

24. The method of claim 23, wherein the tunnel includes an Ethernet switch of the R-PHY equipment.
